(19) United States
(12) Patent Application Publication
(10) Pub. No.: US 2011/0060552 A1
(43) Pub. Date: Mar. 10, 2011

(54) Measuring Apparatus, Measuring Coordinate Setting Method and Measuring Coordinate Number Calculation Method

(75) Inventor: Makoto ONO, Yokohama (JP)

(73) Assignee: Hitachi, Ltd., Tokyo (JP)

(21) Appl. No.: 12/839,025

(22) Filed: Jul. 19, 2010

(30) Foreign Application Priority Data
Sep. 10, 2009 (JP) 2009-208823
Mar. 12, 2010 (JP) 2010-055277

(51) Int. Cl. G06F 15/00; G01B 21/20

(52) U.S. Cl. 702/167

(57) ABSTRACT

With little cost and time, this invention makes high-precision measurements over an entire surface of a substrate to check how well devices are fabricated. The devices include integrated circuits, magnetic heads, magnetic discs, solar cells, optical modules, light emitting diodes and liquid crystal display panels—the ones that are fabricated on a substrate by repetitively performing deposition, resist application, exposure, development and etching. The method of this invention involves inputting multipoint measured data and a number of points used for measurement and calculating measuring coordinates by the measuring coordinate calculation program 1161. Next, based on the calculated measuring coordinates, the measuring program 1162 measures device characteristics, such as dimensions of the devices. Next, the curved surface approximation program 1163 calculates approximated values of device characteristics over the entire surface of the substrate, followed by the output program 1164 outputting the approximated values.

### INCORPORATION BY REFERENCE

The present application claims priorities from Japanese applications JP2009-208823 filed on Sep. 10, 2009, JP2010-055277 filed on Mar. 12, 2010, the contents of which are hereby incorporated by reference into this application.

### BACKGROUND OF THE INVENTION

The present invention relates to a measuring apparatus and a measuring method which examine how well devices are fabricated, the devices including integrated circuits, magnetic heads, magnetic discs, solar cells, optical modules, light emitting diodes and liquid crystal display panels—the ones that are fabricated on a substrate by repetitively performing deposition, resist application, exposure, development and etching. More particularly this invention relates to electronic microscopes and optical microscopes for measuring pattern dimensions of devices, to laser interferometers for measuring the thickness of oxide films and to testing apparatus for measuring electric characteristics and magnetic characteristics of devices.

As substrates, on which devices such as integrated circuits, liquid crystal display panels and magnetic heads are formed, have been growing in surface area in recent years, a quality management problem has come to be recognized. That is, the pattern dimensions, oxide film thicknesses, electric characteristics and magnetic characteristics of the devices formed on the surface of a substrate vary depending on the positions of the devices in the substrate surface.

There is another problem that huge manufacturing cost would result if the fabrication assessment of devices formed is done by measuring such items as pattern dimension, oxide film thickness, electric characteristics and magnetic characteristics at a large number of locations in the substrate surface.

Under these circumstances, the inventors of this invention have studied a technique which selects a number of points for measurement, smaller than the conventional number, from within the substrate surface and takes measurements at only these points and can still assess with high precision how well the devices have been fabricated over the whole surface of the substrate. As another effort to tackle the problem in a way similar to the approach taken by the inventors of this invention, a technique that selects measuring positions according to the experimental planning method has been proposed in “Wafer Mapping Using DOE and RSM Technique”, Proceeding of IEEE International Conference on Microelectronic Test Structures, Volume 8, pages 289-294, March 1995, by Anthony J. Walton, Martin Fallon and Dave Wilson. This technique, however, orderly arranges the measuring positions in a point-symmetric manner, beginning with the center of the substrate, and approximates a response surface function to optimize the measuring positions. Further, in “Wafer Sampling by Regression for Systematic Wafer Variation Detection”, Proceedings of SPIE, Volume 5755, pages 212-221, 2005, by Byungsool Moon, James McNames, Bruce Whitefield, Paul Rudolph and Jeff Zola, another technique is described which involves classifying a distribution of assessed fabrication level of devices formed on a substrate surface into an assessment group associated with a stepper and an assessment group associated with other than the stepper, approximating the assessment group associated with other than the stepper by polynomials and optimizing the measuring positions in ways that minimize approximation errors. In JP-A-2007-287742 still another technique is proposed which involves approximating orthogonal polynomials and optimizing the measuring positions so as to minimize approximation errors. These techniques, however, perform approximation with fixed mathematical expressions. So there is no guarantee that the assessment level of device fabrication can be evaluated over the entire surface of the wafer with high precision. On the other hand, a technique described in JP-A-2005-317864 approximates data measured at a small number of measuring positions with a B-spline surface and Bezier surface and utilizes the approximation result for an end-point control of CMP (Chemical Mechanical Polishing). This technique, however, does not make any reference to the measuring positions in the substrate surface.

### SUMMARY OF THE INVENTION

This invention provides a measuring apparatus and a measuring method which respond to a demand for a capability that makes it possible to take measurements only at a small number of measuring positions in a surface of a substrate, approximate with a curved surface a distribution of measured values on the substrate surface and evaluate assessment level of device fabrication over an entire surface of the substrate with high precision.

With the measuring apparatus and the measuring method of this invention, it is possible to obtain pattern dimension data, oxide film thickness data, electric characteristic data and magnetic characteristic data over an entire surface of a substrate. We provide a method for analyzing a cause of failure of a product, such as a magnetic recording apparatus, that incorporates the magnetic heads or magnetic discs and their characteristic data described above.

This invention solves the aforementioned problem by providing a measuring apparatus designed to measure characteristics of devices formed on a substrate such as wafer and disc, which comprises: a measuring coordinate calculation means to read multipoint measured data and a number of points for measurement and calculate appropriate measuring coordinates; a measuring means to measure device characteristics at the measuring coordinates on the surface of the substrate; a curved surface approximation means to approximate a curved surface from the measuring coordinates and the device characteristics corresponding to these coordinates; and an output means to output the approximated device characteristics from the result of the curved surface approximation of the substrate. As another way of solving the above problem, a measuring apparatus is provided which comprises: a measuring coordinate calculation means to calculate measuring coordinates by combining randomly chosen coordinates on the substrate surface with coordinates located along an outer circumference of the substrate; a measuring means to measure device characteristics at the measuring coordinates on the surface of the substrate; a curved surface approximation means to approximate a curved surface from the measuring coordinates and the device characteristics corresponding to these coordinates; and an output means to output the approximated device characteristics from the result of the curved surface approximation of the substrate.

By applying the measuring apparatus and the measuring method of this invention to the device fabrication process, the assessment level of device fabrication can be evaluated over the entire surface of the substrate with high precision. This allows variations in device characteristics to be examined precisely over the entire substrate surface, making it possible to improve the performance of the devices and quickly analyze a cause of failure of a product incorporating the devices. Further, with the number of measuring points on the substrate surface reduced, the number of measuring apparatus can be reduced and therefore facility investment minimized.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing an example of overview of an electron microscope.

FIG. 2 shows an example of flow chart of a measuring coordinate calculation program.

FIG. 3 shows an example of flow chart of a measuring coordinate optimization program.

FIG. 4 shows an example of flow chart of a measuring program.

FIG. 5 shows an example of flow chart of a curved surface approximation program.

FIG. 6 shows an example of flow chart of an output program.

FIG. 7 shows an example of a substrate or wafer, an exposure shot in the substrate and coordinates in the substrate.

FIG. 8 shows an example of coordinates in the exposure shot.

FIG. 9 shows an example of multipoint measured data.

FIG. 10 shows an example of data randomly sampled from the multipoint measured data.

FIG. 11 shows an example list of neighboring coordinates.

FIG. 12 shows an example list of neighboring coordinates for randomly sampled coordinates.

FIG. 13 shows an example of wafer map of randomly sampled coordinates.

FIG. 14 shows an example of calculated coordinate data.

FIG. 15 shows an example of wafer map of calculated coordinate data.

FIG. 16 shows an example of wafer map of calculated coordinate data.

FIG. 17 shows an example flow chart of a program for combining the random sampling coordinates and the curved surface approximation measuring coordinates.

FIG. 18 shows an example wafer map of the randomly sampled coordinates.

FIG. 19 shows an example wafer map of the curved surface approximation measuring coordinates.

FIG. 20 shows an example of error calculation flow chart as a variable S is changed.

FIG. 21 shows an example flow chart of the measuring coordinate calculation program.

FIG. 22 shows an example of error graph with respect to a variable S.

FIG. 23 shows an example flow chart of the measuring coordinate optimization program.

FIG. 24 shows an example flow chart of the measuring coordinate optimization program.

FIG. 25 shows an example of data that ties the measured data obtained through the examination of how well the substrate has been fabricated to the result of final tests on final products.

FIG. 26 shows an example flow chart of the measuring coordinate calculation program.

FIG. 27 shows an example flow chart of the measuring coordinate optimization program.

### DESCRIPTION OF THE EMBODIMENTS

Embodiments of the present invention will be described in detail by referring to the accompanying drawings.

### Embodiment 1

First, an electron microscope to measure dimensions of patterns formed on a device will be explained as embodiment 1.

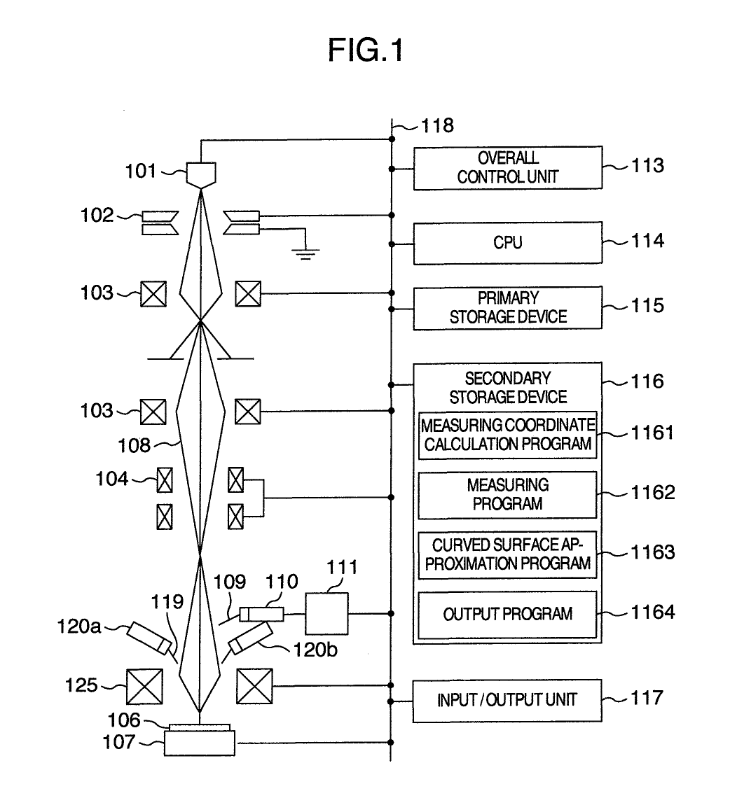

FIG. 1 shows an overview of an electron microscope as one example of a measuring apparatus of this invention. The electron microscope comprises an electron source 101 for generating primary electrons 108, an acceleration electrode 102 for accelerating the primary electrons, a focusing lens 103 for focusing the primary electrons, a deflector 104 for deflecting the primary electrons two-dimensionally and an object lens 105 for focusing the primary electrons onto a substrate 106 such as wafer. Denoted 107 is a drive stage on which the substrate 106 is mounted. Designated 110 is a detector that detects a secondary electron signal 109 coming out of the substrate 106. Denoted 120a and 120b are reflected electron detectors that each detect a reflected electron signal 119. In the figure, the two reflected electron detectors 120a, 120b are set to oppose each other and intended to detect different components of the reflected electron signal from the substrate 106. Denoted 111 is a digital converter to digitize the detected signal. These components are connected through a bus 118 to an overall control unit 113. This electron microscope also has a central processing unit (CPU) 114, a primary storage device 115, a secondary storage device 116, a keyboard, a mouse, a display, a printer and an input/output unit 117 such as network interface. In the secondary storage device 116 are installed a measuring coordinate calculation program 1161 that sets optimum measuring coordinates for use in the measurement of the surface of the substrate 106; a measuring program 1162 that measures predetermined dimensions at the set measuring coordinates; a curved surface approximation program 1163 that approximates an entire surface of the substrate, based on the measuring coordinates and the measured dimensions; and an output program 1164 that outputs the dimension data approximated with a curved surface and the dimension map of the entire surface of the substrate to the input/output unit 117. These programs are read out from the secondary storage device 116 to the primary storage device 115 and executed by the CPU 114.

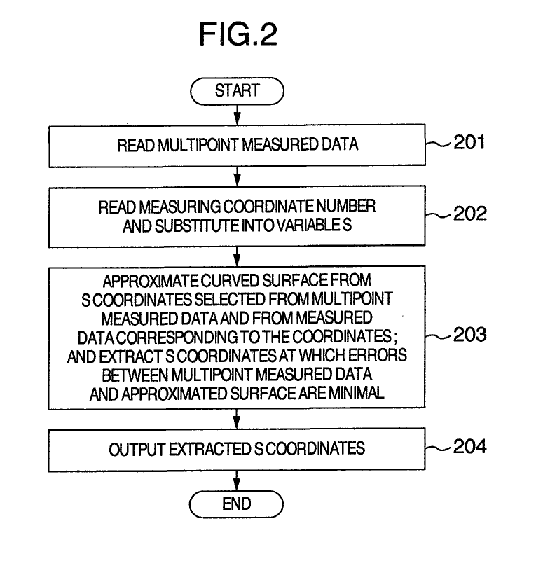

FIG. 2 shows an example flow chart of the measuring coordinate calculation program 1161. At step 201, dimension data experimentally measured beforehand at many positions on the entire surface of the substrate, i.e., multipoint measured data, is read in. This dimension data is preferably generated by taking measurements at as many positions as possible on a plurality of substrates that can be deemed to be of the same kind and calculating their average for each position. It is preferred that the many positions correspond to the positions of all devices formed on the substrate surface. Where several tens to several hundreds of devices are to be formed in the substrate surface, as with a system LSI, data can often be prepared by measuring dimensions for all devices. On the other hand, where tens of thousands of devices are to be formed in the substrate surface, as with magnetic heads and μ-chips, it is difficult to measure dimensions of all devices in terms of time. In that case, data does not have to be taken from all devices but need only be sampled at predetermined intervals. The data may also be sampled and measured at predetermined intervals, followed by being approximated with a B-spline surface. Next, at step 202, the number of coordinates at which measurements are to be made by the measuring apparatus of this invention is read in and substituted into the variable S. The appropriate number of coordinates where measurements are taken is determined based on, for example, the number of substrates fabricated daily at the device mass production plant, the number of measuring apparatus available in the plant and the processing speed of the measuring apparatus so that the number of coordinates used for measurement does not hinder the intended productivity. More specifically, measurements are made at about 10 to 50 locations on the substrate surface, depending on the kind of device.

Next, step 203 selects from the multipoint measured data read in by step 201 the same number of coordinates as the number of measuring coordinates substituted into the variable S. From the selected coordinates and the dimension data corresponding to these coordinates, a curved surface is approximated and then S coordinates are extracted where errors between the multipoint measured data and the approximated curved surface are minimal. More specifically, an optimization method that combines any of the hill climbing algorithm, multi-start algorithm, simulated annealing algorithm and hereditary algorithm is used to extract S coordinates. Next, at step 204 the S coordinates extracted by step 203 are written out.

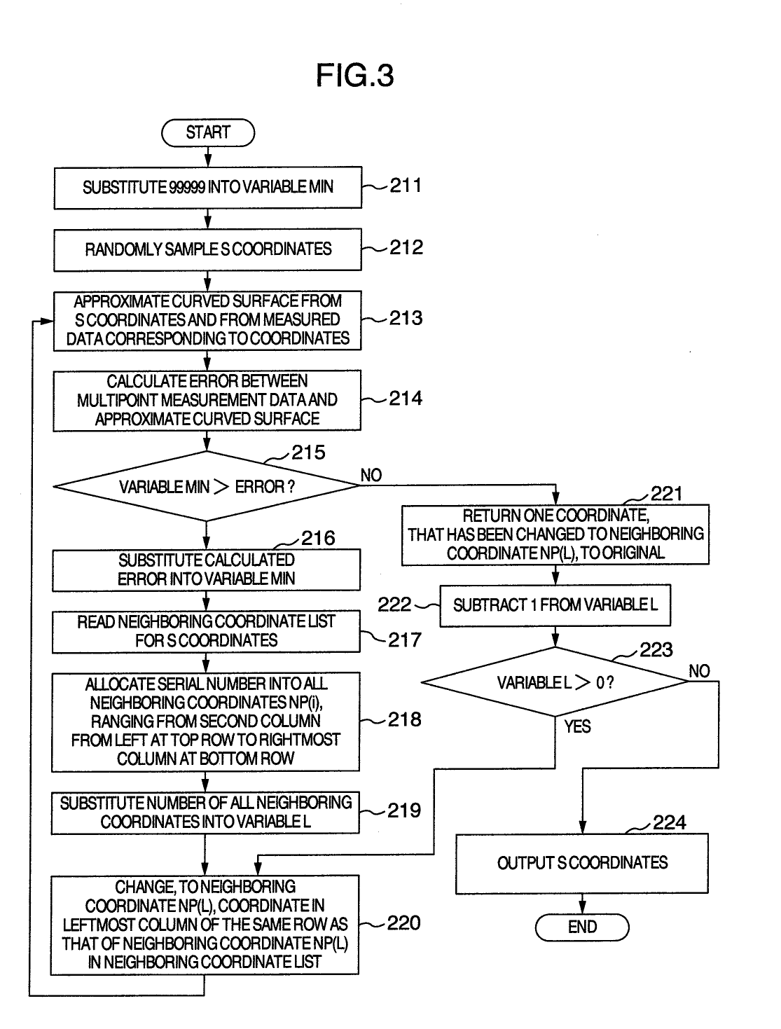

FIG. 3 is an example flow chart showing the processing of the step 203 in greater detail that uses the hill climbing algorithm, the most common local search algorithm. At step 211, an extremely large value is substituted in a variable MIN. While 99999 is shown in the figure, any value can be used as long as it is large. Next, at step 212, S coordinates are sampled randomly from the multipoint measured data read in by step 201. Then at step 213, using the sampled S coordinates and the dimension data corresponding to these coordinates, a curved surface is approximated. More specifically, although the inventors of this invention use a B-spline surface for the approximation, the approximation method is not limited to the B-spline surface. Other methods include one that approximates various free curved surfaces and which is used in 3-dimensional CAD and for restoration of 3-dimensional images, and also an application of polynomials to curved surfaces. Next at step 214, errors between the multipoint measured data and the approximated curved surface are calculated. The errors can be calculated by equation 1.

$$RMSE = \sqrt{\frac{{\sum }_{i = 1}^{N} {( {X}_{i} - {Y}_{i} )}^{2}}{N}} \qquad ( Equation 1 )$$

Here, Xi represents a dimension value of the multipoint measured data at each measuring point (coordinate) and Yi represents a value of the approximated curved surface for each measuring point (coordinate). N represents the number of measuring points of the multipoint measured data.

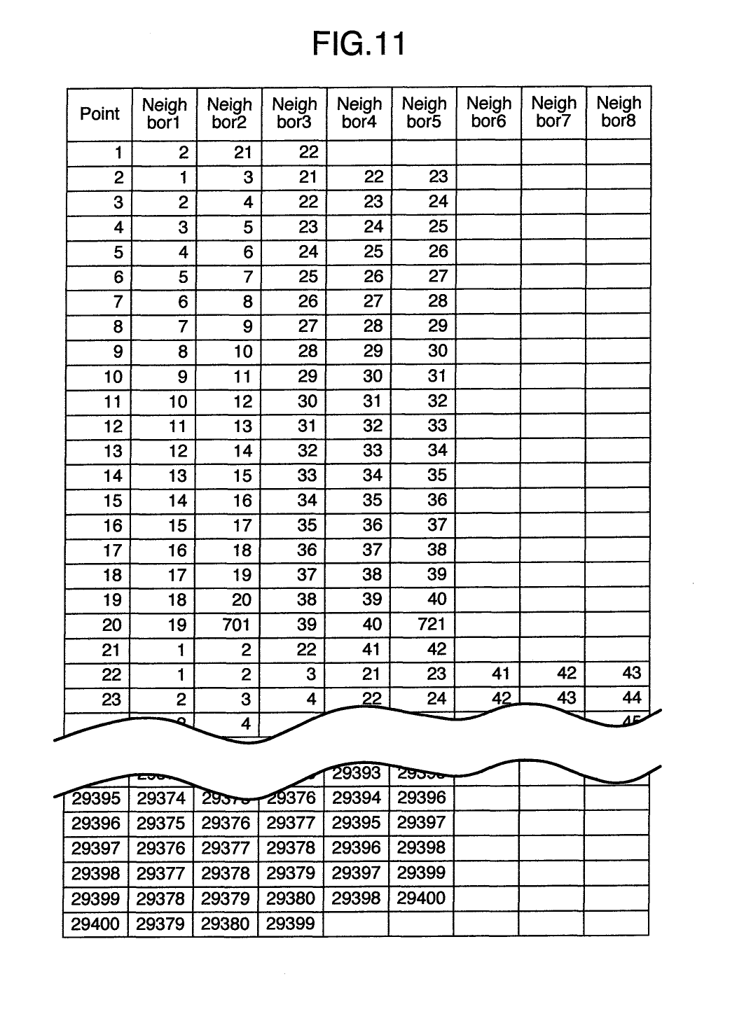

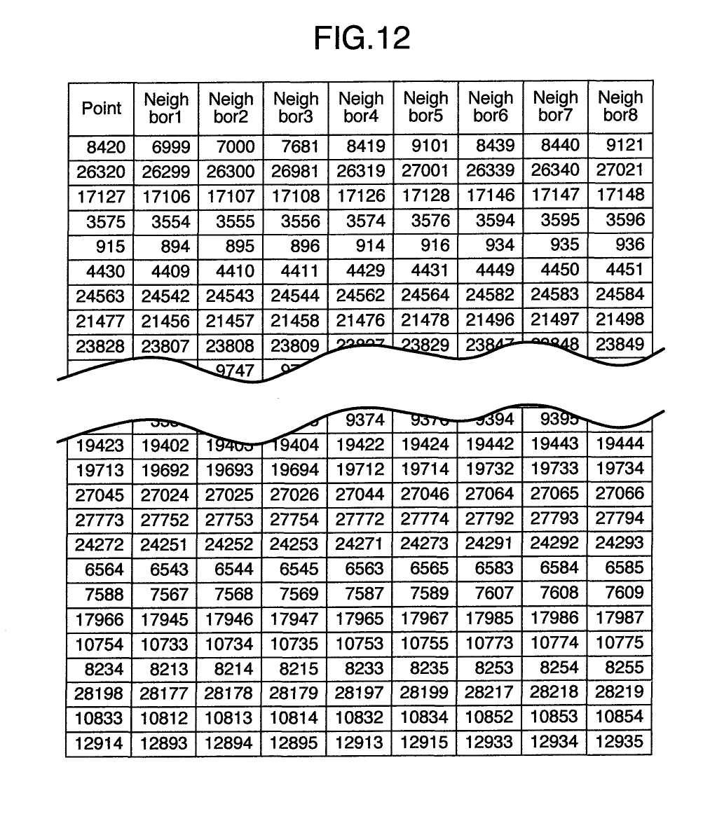

Next, step 215 compares the variable MIN and the error. If the variable MIN is found to be greater than the error, the processing proceeds to step 216. If not, the processing moves to step 221. At step 216, the error is substituted into the variable MIN. Next, at step 217, a neighboring coordinate list for the S coordinates is read in. (As described later, the neighboring coordinate list shown in FIG. 11 is a list of neighboring measuring coordinates that are, for example, in an 8-neighbor positional relation with each of the randomly sampled S measuring coordinates, as shown in FIG. 12.) Next, at step 218, a serial number i is assigned to all neighboring coordinates NP(i) in the read neighboring coordinate list (see FIG. 12) ranging from the second column of top row to the rightmost column of bottom row. Next, step 219 substitutes the number of all neighboring coordinates into the variable L. Next, at step 220, the coordinate of the leftmost column of the same row as the neighboring coordinate NP(L) in the neighboring coordinate list is changed to the neighboring coordinate NP(L), and the processing returns to step 213.

If, on the other hand, the processing moves from step 215 to step 221, the one coordinate at the leftmost column that has been changed by step 220 to the neighboring coordinate NP(L) is returned to the original value. Next, step 222 subtracts 1 from the variable L. Then, if step 223 finds that the variable L is larger than 0, the processing moves to step 220. If it is smaller than 0, the processing moves to step 224, where it outputs S coordinates used.

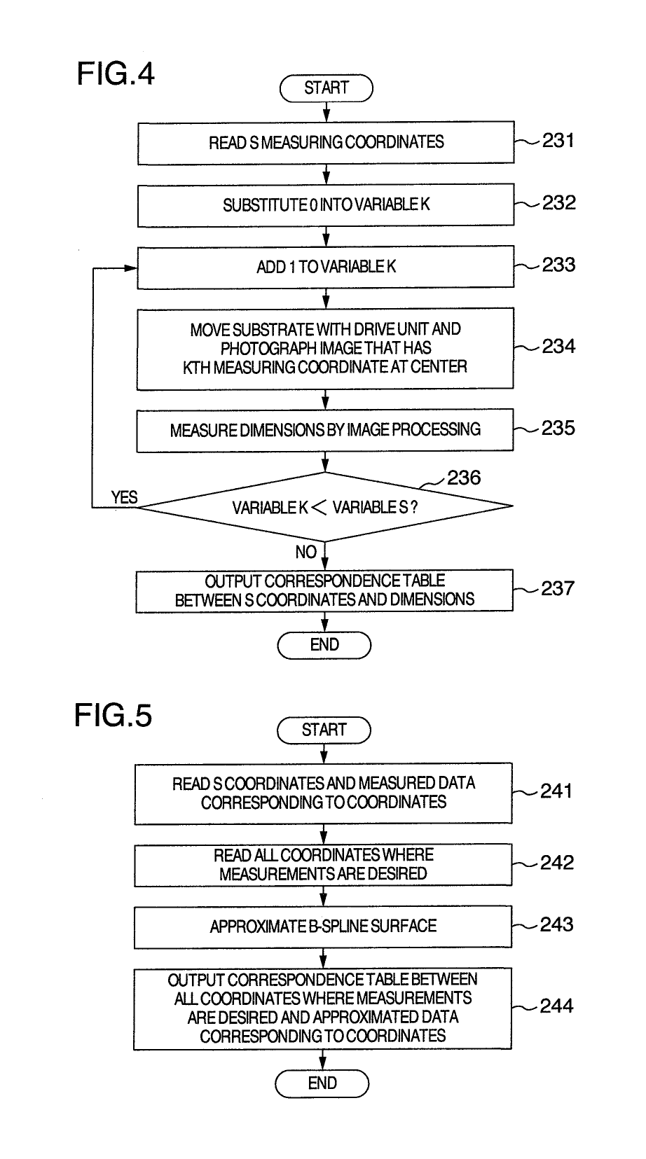

FIG. 4 shows an example flow chart of the measuring program 1162. Step 231 reads the S measuring coordinates determined by the measuring coordinate calculation program 1161. Next, step 232 substitutes 0 into a variable K. Next, step 233 increments the variable K by 1. Then at step 234, the drive stage 107 is operated to move the substrate 106, and an image that has a Kth measuring coordinate positioned at its center is photographed. Next, step 235 performs image processing to measure pattern dimensions in the photographed image. If step 236 finds that the variable K is smaller than the variable S, the processing returns to step 233. If the variable K is greater than the variable S, the processing moves to step 237, where it outputs a correspondence table between the S coordinates and the S measured dimensions.

FIG. 5 shows an example flow chart of the curved surface approximation program 1163. Step 241 reads the S coordinates written out by step 237 and the measured data corresponding to these coordinates, i.e., dimension data. Next, step 242 reads all the coordinates at which measurements are desired to be taken. All the coordinates at which measurements are desired to be taken are often the same as the coordinates of the multipoint measured data read in by step 201. It is noted, however, that the coordinates may differ from the multipoint measured data. Next, step 243 approximates a B-spline surface for the S coordinates and their associated measured data read in by step 241. Next, step 244 calculates values on the approximated B-spline surface, or approximated data, for all the coordinates read in by step 242 where measurements are desired to be made. It then creates a correspondence table between all the coordinates desired to be measured and the approximated data corresponding to these coordinates. Although the B-spline surface has been used here as the curved surface approximation method, other methods may also be used, such as a method of approximating various free curved surfaces used in 3-dimensional CAD and for restoration of 3-dimensional images and a quadratic curved surface. While, in approximating the B-spline surface, the inventors of this invention have used the method described in “Scattered Data Interpolation with Multilevel B-Splines,” by Seungyong Lee, George Wolberg and Sung Yong Shin, IEEE Transactions on Visualization and Computer Graphics, Volume 3, Number 3, pages 228-224, July-September, 1997, other methods may also be used.

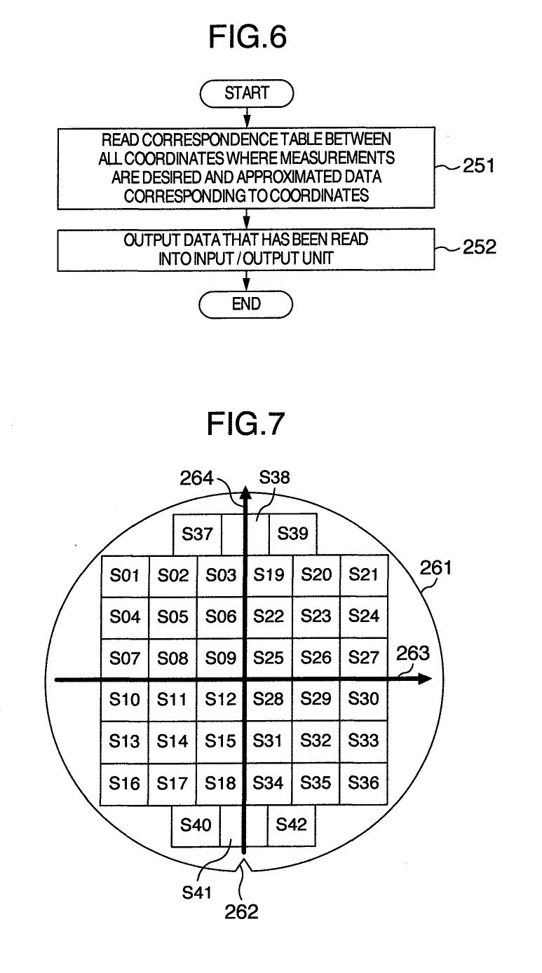

FIG. 6 shows an example flow chart of the output program 1164. Step 251 reads a correspondence table between all the coordinates written out by step 244 where measurements are desired to be made and the approximated data corresponding to these coordinates. Next, step 252 outputs the read data into the input/output unit.

FIG. 7 shows an example of a substrate whose dimensions are to be measured by the measuring apparatus of this invention. This substrate is a wafer 261 that forms a magnetic head which reads and writes bit information on a magnetic disc surface in a magnetic recording device. A blank circle represents the wafer 261, which is formed with a notch 262 for positioning. Blank rectangles S01 to S42 represent areas where a pattern is exposed in 42 parts by a step & repeat type stepper, and are defined as exposure shots. An abscissa (X axis) 263 and an ordinate (Y axis) 264 are virtually set with reference to the notch 262 position and the wafer center in order to define coordinates in the wafer surface.

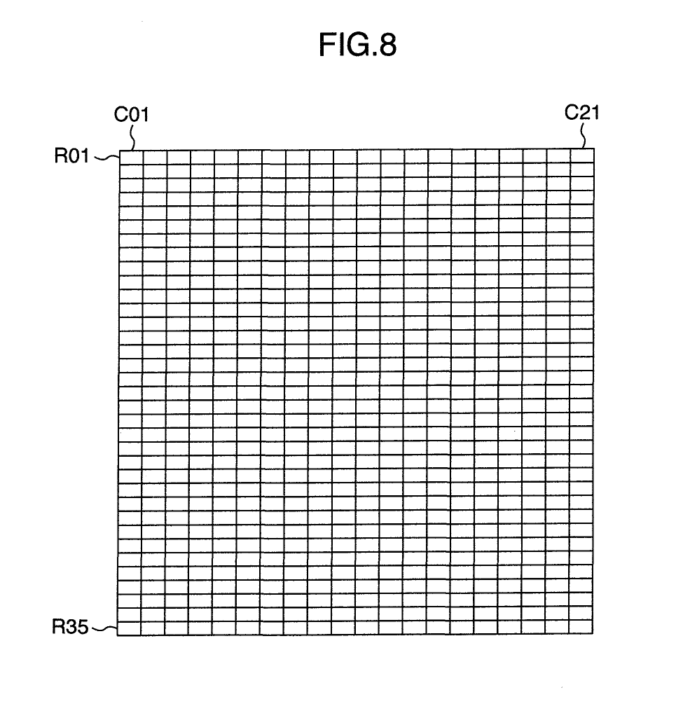

FIG. 8 shows an example coordinate system in each of the exposure shots S01 to S42. In this example, magnetic heads are arranged in 35 rows by 20 columns in each exposure shot. The ordinate is defined to range from R01 to R35 and the abscissa from C01 to C20 so that individual magnetic heads can be uniquely identified. In each exposure shot a total of 700=35×20 magnetic heads are formed. That is, in one substrate a total of 700×42=29,400 magnetic heads are formed.

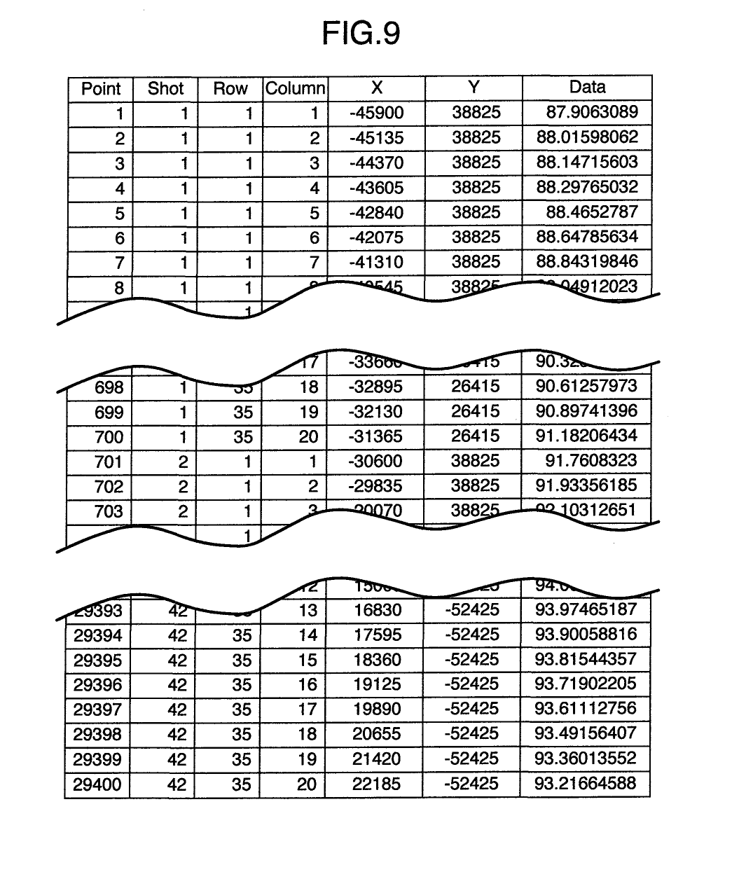

FIG. 9 shows an example of multipoint measured data read in by step 201. As described above, this is a result of experimentally measuring dimensions of 29,400 magnetic heads that can be fabricated on the substrate 261. If it is difficult to measure dimensions of all of the 29,400 magnetic heads because of the processing speed of the measuring apparatus, one magnetic head for every 100, or a total of 294 magnetic heads, may be measured and the dimensions thus obtained may be substituted for 29,400 pieces of data approximated with the B-spline surface. Columns of the multipoint measured data include: serial numbers of magnetic heads (Point), an exposure shot number (Shot), a coordinate of the ordinate in each exposure shot (Row), a coordinate of the abscissa in each exposure shot (Column), an X coordinate for the abscissa 263, a Y coordinate for the ordinate 264, and dimension data. Rows of the multipoint measured data represent magnetic heads. In this example, the multipoint measured data are arrayed in 29,400 rows. For example, it is seen that a magnetic head with a serial number (Point) of 702 lies within an exposure shot of S02 and, in that exposure shot, is situated at R01 and C02. Its position with respect to the entire surface of the substrate is −29835 in X coordinate and 38825 in Y coordinate and its dimension is 91.93356185 nanometer.

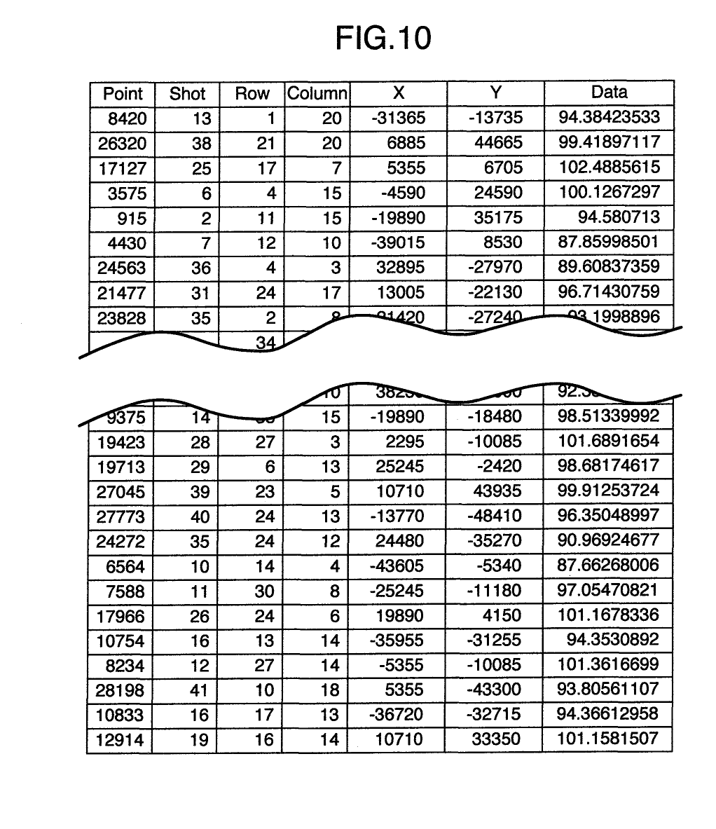

FIG. 10 shows an example result of step 212 that has randomly sampled S pieces of data from the multipoint measured data shown in FIG. 9. In this example, 50 is substituted into the variable S.

FIG. 11 shows an example of a neighboring coordinate list for all magnetic heads of the wafer 261. The neighboring coordinate list is a table that lists serial numbers of all magnetic heads (Point) and serial numbers of magnetic heads immediately neighboring the first magnetic heads. Take a magnetic head of Point 1 for example. It is situated at the end of the substrate, which means that those magnetic heads immediately adjoining it are three magnetic heads with serial numbers (Point) 2, 21 and 22. Magnetic heads immediately adjoining a magnetic head of Point 22, which is situated on the side nearer to the center of the substrate than the magnetic head of Point 1, are eight magnetic heads of Point 1, 2, 3, 21, 23, 41, 42 and 43.

FIG. 12 shows an example list of coordinates neighboring the S measuring coordinates, the neighboring coordinates being extracted and read in by step 217 from the neighboring coordinate list of FIG. 11. This is the result of extracting from the neighboring coordinate list of FIG. 11 only those rows having the same serial numbers (Point) as in FIG. 10.

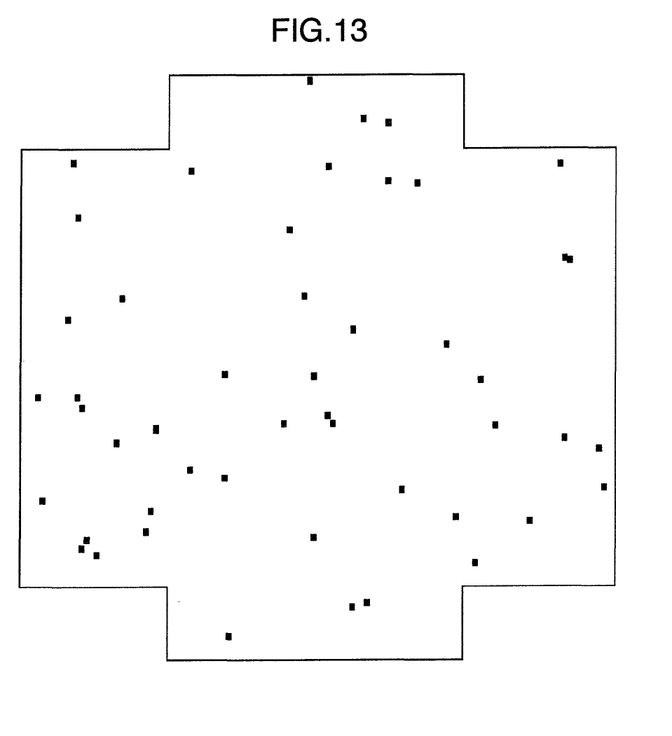

FIG. 13 is a result of mapping the positions of magnetic heads based on the X and Y coordinates of randomly sampled data of FIG. 10. An enclosing line represents an outer circumference of an area on the wafer 261 in which the magnetic heads actually exist, with small black square dots representing the positions of the mapped magnetic heads. This indicates that the selected magnetic heads are scattered at roughly random positions.

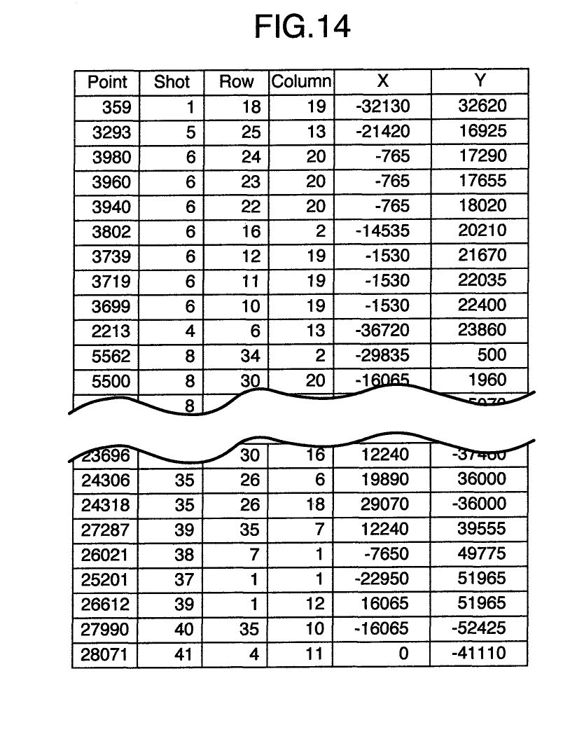

FIG. 14 shows an example of 50 pieces of coordinate data produced by step 204 when the variable S is 50. In other words, this is an example of the measuring coordinates read in by the measuring program 1162 at step 231.

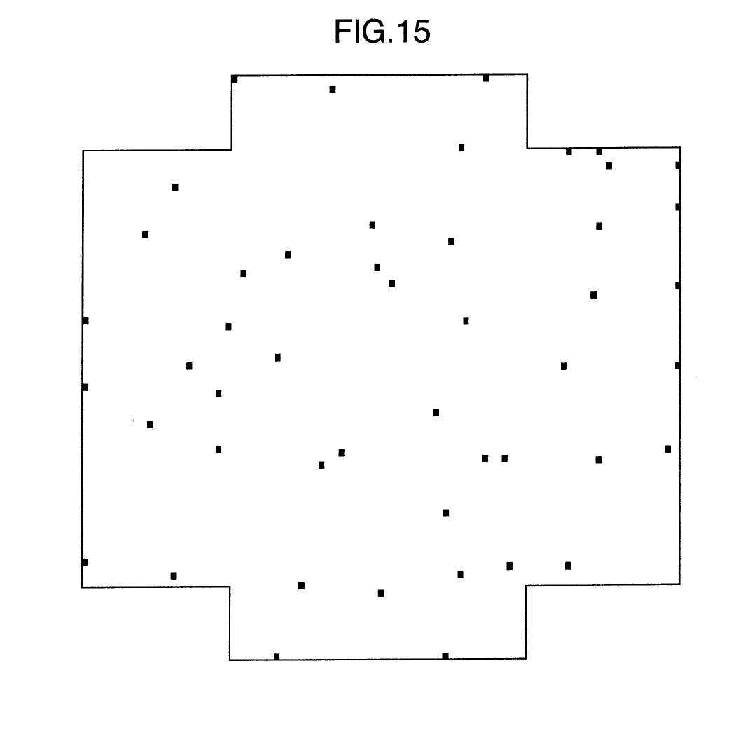

FIG. 15 shows, as in FIG. 13, a result of mapping the positions of the magnetic heads based on the X and Y coordinates of data of FIG. 14. An enclosing line represents an outer circumference of an area on the wafer 261 where the magnetic heads actually exist, with small black square dots representing the positions of the mapped magnetic heads. Comparison between FIG. 13 and FIG. 15 shows that a greater number of black square dots is lying near the enclosing line in FIG. 15. It is also seen that, at other positions than those close to the enclosing line, the black square dots are more evenly scattered. This means that while the measurements at positions close to the enclosing line are important because the B-spline surface approximation is better at interpolation than exterpolation, it is also important to have the black square dots evenly scattered over the wafer surface in minimizing overall errors.

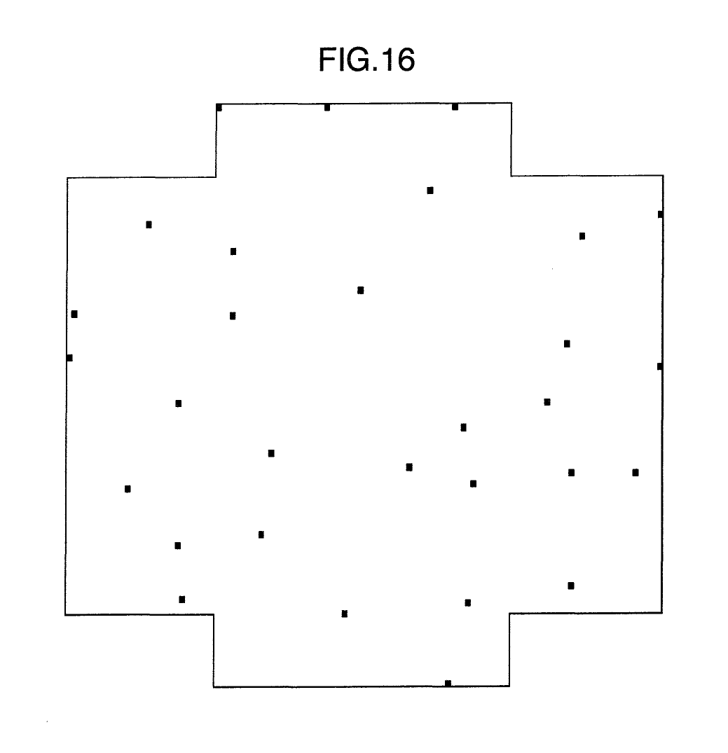

FIG. 16 shows an example result of the magnetic head position mapping when the variable S is 30. It is seen that, even with the variable of 30, many black square dots are lying near the enclosing line, as in FIG. 15.

As described above, the measuring apparatus of this invention normally can automatically determine the coordinates at which measurements are to be taken, by experimentally preparing the multipoint measured data and determining the number of measuring points that is indicated at the variable S. The measuring apparatus, by making measurements at the determined measuring coordinates, can obtain, with fewer measuring points, approximated values that are close to the values of the multipoint measurement.

In embodiment 1, an example method has been shown in which dimensions are measured by the measuring program 1162 using the measuring coordinates calculated by the measuring coordinate calculation program 1161. It is noted, however, that the measuring coordinates may simply be set by the measuring coordinate calculation program 1161 without using an optimization method, that combines the hill climbing algorithm shown in FIG. 3, other simulated annealing methods and hereditary algorithm. Then the measuring program 1162 may measure dimensions at the simply set coordinates. For example, as shown in FIG. 15, the S measuring coordinates determined by the combined optimization method are often calculated to be at positions neighboring the outer circumference of the wafer, i.e., the enclosing line in the figure.

### Embodiment 2

Therefore, with this tendency considered, the following measuring coordinate calculation program may be used as embodiment 2.

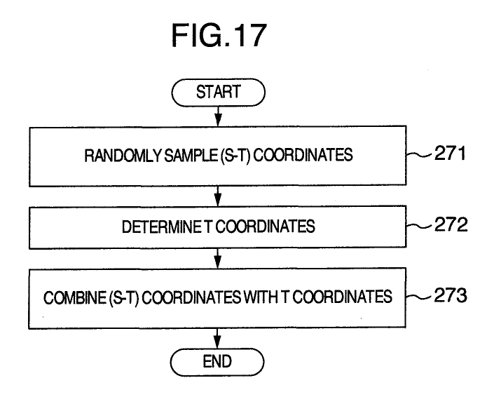

FIG. 17 shows an example flow chart that simplifies the measuring coordinate calculation program 1161. First, at step 271, a variable S and a variable T are arbitrarily set to randomly sample (S-T) coordinates. Next, step 272 arranges T coordinates along the outer circumference of the wafer to reduce approximation errors of the B-spline surface. Next, step 273 combines the (S-T) coordinates randomly sampled by step 271 with the T coordinates used for curved surface approximation at step 272, to calculate S coordinates.

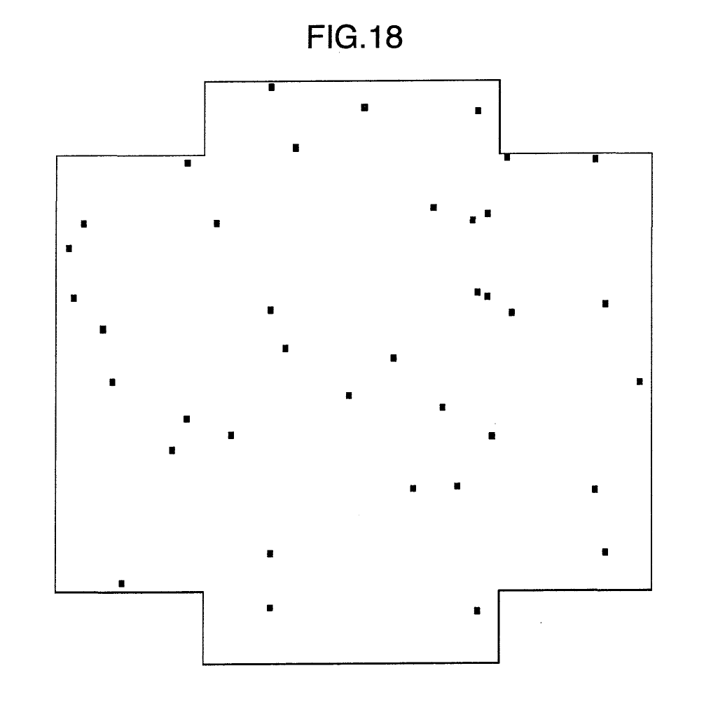

FIG. 18 shows an example of wafer map of the (S-T) coordinates randomly sampled at step 271.

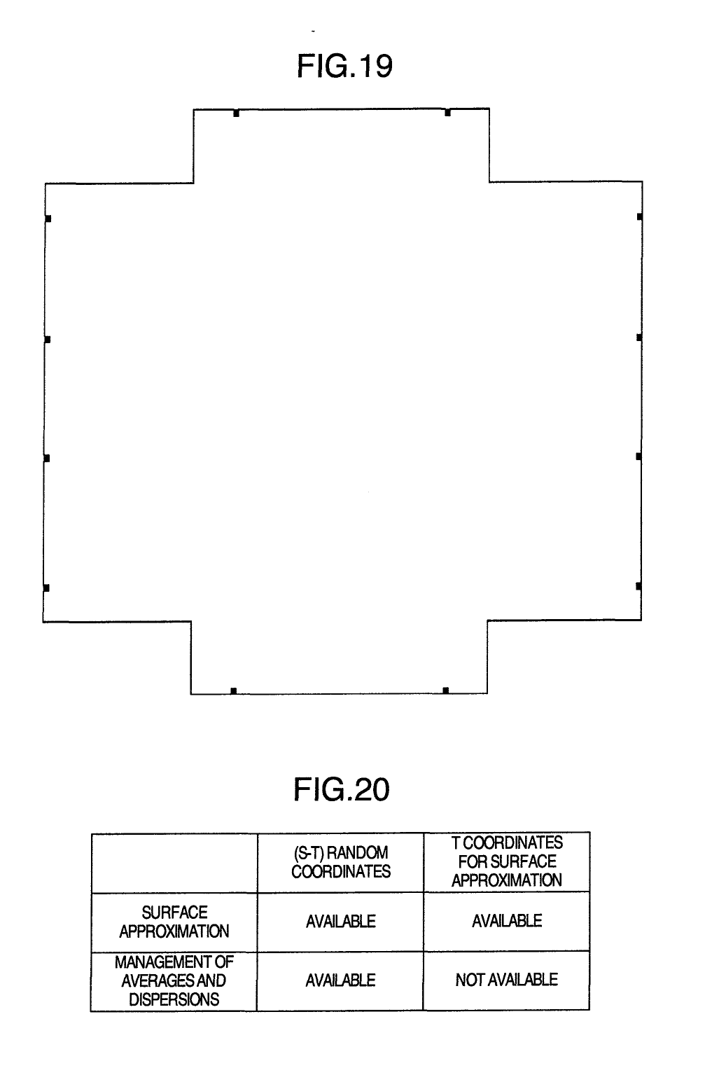

FIG. 19 shows an example of wafer map of the T coordinates that are deliberately placed along the outer circumference of the wafer at step 272.

FIG. 20 shows an example of table that shows how the dimension data measured at the S coordinates generated by the flow chart of FIG. 17 should be used according to applications. To determine how well the entire wafer has been fabricated by using a curved surface approximation method such as a B-spline surface, all of the S pieces of measured data are used. On the other hand, in generating a management diagram dotted with averages and dispersions of measured data for individual wafers, randomness becomes an important factor, so that only the measured data for the randomly sampled (S-T) coordinates may be used.

### Embodiment 3

In embodiment 1 and 2, an appropriate number of measuring coordinates that does not impair the productivity is determined by taking into consideration the number of wafers manufactured daily at the device mass production plant, the number of measuring apparatus available at the plant and the processing speed of the measuring apparatus, and is substituted into the variable S at step 202. There are, however, cases where it is desired that the number of measuring coordinates be determined from the standpoint of reducing errors of the approximated values obtained through the curved surface approximation. In embodiment 3, therefore, a method of determining the number of measuring coordinates from the standpoint of reducing errors of approximated values will be explained.

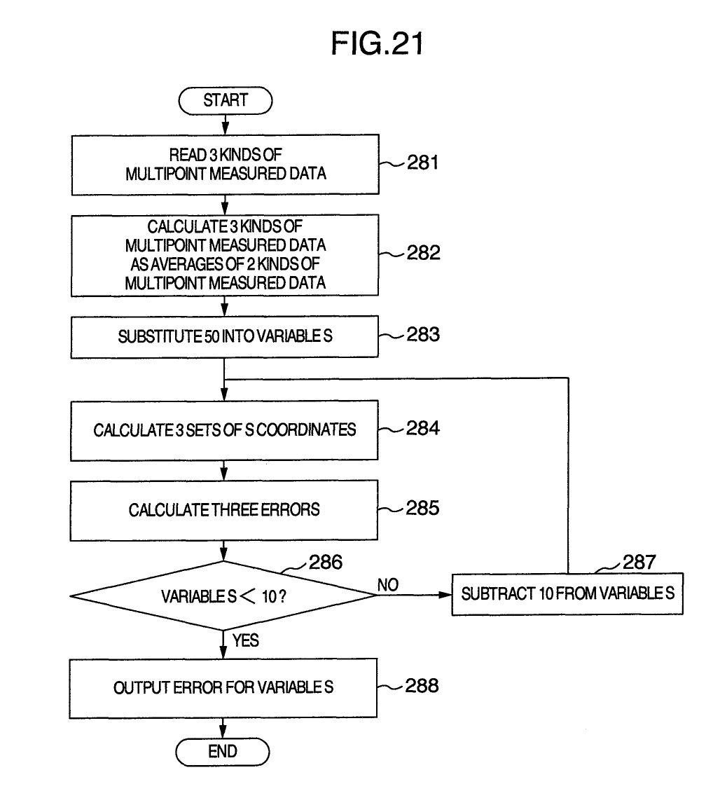

FIG. 21 shows an example flow chart to evaluate errors for the variable S by preparing three kinds of multipoint measured data. This method evaluates errors by using a cross validation. First, step 281 reads three kinds of multipoint measured data. Here, the three kinds of multipoint measured data are named, for example, M1, M2 and M3. Next, at step 282, as averages of two kinds of multipoint measured data, three kinds of multipoint measured data are calculated. More specifically, multipoint measured data M1 and multipoint measured data M2 are used to calculate an average for each corresponding coordinate and create new multipoint measured data A1. Similarly, multipoint measured data M2 and multipoint measured data M3 are used to calculate an average for each corresponding coordinate, creating new multipoint measured data A2. Similarly, multipoint measured data M3 and multipoint measured data M1 are used to calculate an average for each corresponding coordinate, creating new multipoint measured data A3. Next step 283 substitutes 50 into the variable S. Then, step 284 calculates, according to the flow charts of FIG. 2 and FIG. 3, S optimum measuring coordinates for the multipoint measured data A1, S optimum measuring coordinates for the multipoint measured data A2 and S optimum measuring coordinates for the multipoint measured data A3. Next, at step 285, by using the calculated measuring coordinates for the multipoint measured data A1, errors of the multipoint measured data M2 and errors of the multipoint measured data M3 are calculated according to equation 1 and their averages are determined. This step also calculates errors of the multipoint measured data M1 and errors of the multipoint measured data M3 according to equation 1 by using the measuring coordinates calculated for the multipoint measured data A2 and determines their averages. Further, this step calculates errors of the multipoint measured data M1 and errors of the multipoint measured data M2 according to equation 1 by using the measuring coordinates calculated for the multipoint measured data A3 and determines their averages. Furthermore, the three kinds of calculated averages are averaged as errors for the variable S. Step 286 compares the variable S and a value 10 and, depending on the result of comparison, moves to step 287 or step 288. If the processing moves to step 287, it subtracts 10 from the variable S before returning to step 284. If it moves to step 288, it outputs the errors for the variable S.

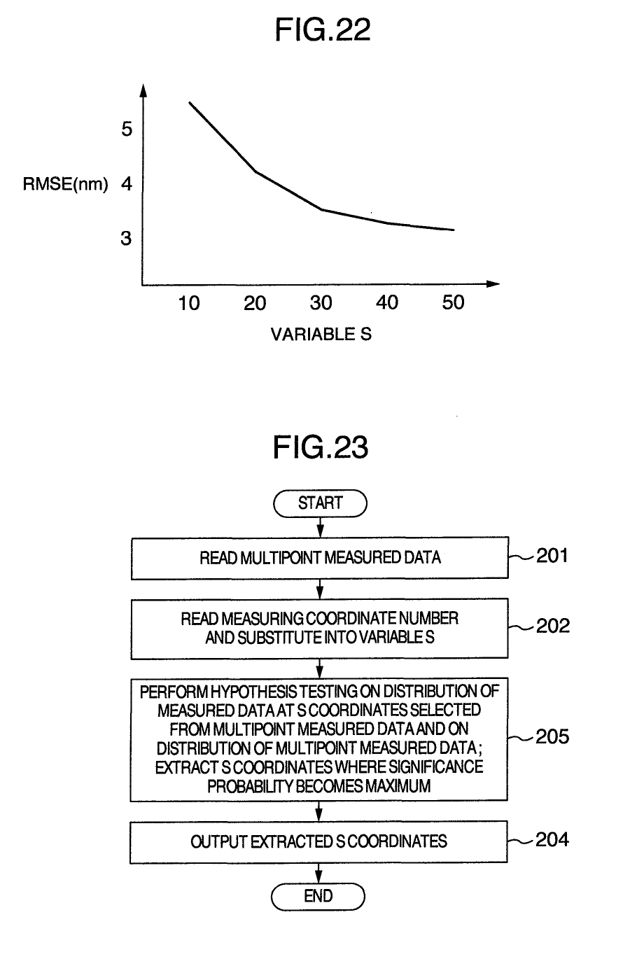

FIG. 22 shows an example graph of errors for the variable S output by step 288. The abscissa ranges from variable 10 to 50 and the ordinate represents errors. The errors output by the step 288 are dotted in the graph and connected with line segments. With the errors for the variable S output as a graph, an optimum value of the variable S can be determined for a target error.

### Embodiment 4

So far, the preceding embodiments have explained, as the measuring coordinate calculation program 1161, methods that involve approximating a curved surface, such as B-spline surface, based on the S selected coordinates and determining measuring coordinates that render approximation errors minimal. There are, however, users who want a method that makes averages and dispersions of measured data for the S selected measuring coordinates equivalent to the multipoint measured data, rather than the method that makes the approximation errors of the approximated curved surface minimal. Under this circumstance, a method that considers the equivalence to the multipoint measured data as an important factor is described in the following as embodiment 4.

FIG. 23 shows an example flow chart of the measuring coordinate calculation program 1161. Step 201, step 202 and step 204 are the same as the corresponding steps in FIG. 2. Step 205, differing from step 203, performs a statistical hypothesis testing on a distribution of measured data for the S coordinates selected from the multipoint measured data and on a distribution of the multipoint measured data to extract S coordinates where significance probabilities or p-values become maximum. The statistical hypothesis testing uses, for example, the t-test, generally described in statistics textbooks, that evaluates differences between averages, the F-test that evaluates differences between dispersions and the Kolmogorov-Smirnov test that evaluates differences between distribution geometries.

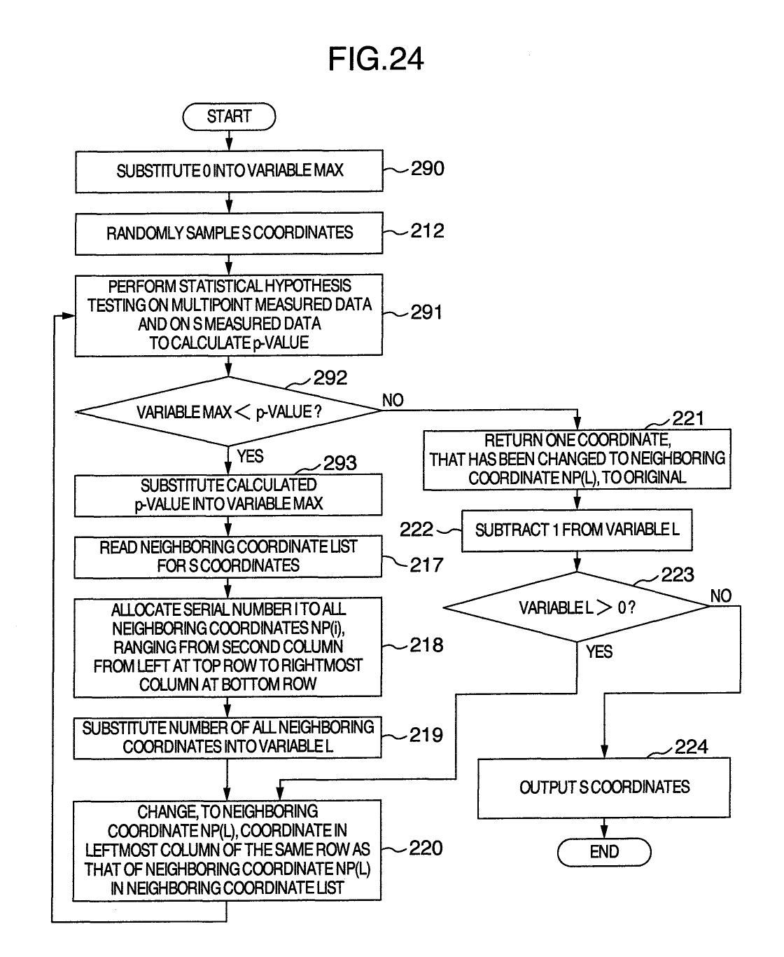

FIG. 24 shows an example flow chart, giving detailed explanation of step 205, when a hill climbing algorithm is used. Step 212, step 217, step 218, step 219, step 220, step 221, step 222, step 223 and step 224 are the same as the corresponding steps in FIG. 3. On the other hand, step 290, step 291, step 292 and step 293 differ from FIG. 3. Step 290 substitutes 0 into the variable MAX. Step 291 executes the statistical hypothesis testing on the multipoint measured data and on the S pieces of measured data to calculate significance probabilities, i.e., p-values. Step 292 determines whether the processing should move to step 293 or step 221, depending on the magnitudes of the variable MAX and the p-value calculated at step 291. Step 293 substitutes the p-value calculated at step 291 into the variable MAX.

### Embodiment 5

As embodiment 5, one example method is explained in the following which uses measured data, approximated by a curved surface, to analyze failures of devices formed on the wafer.

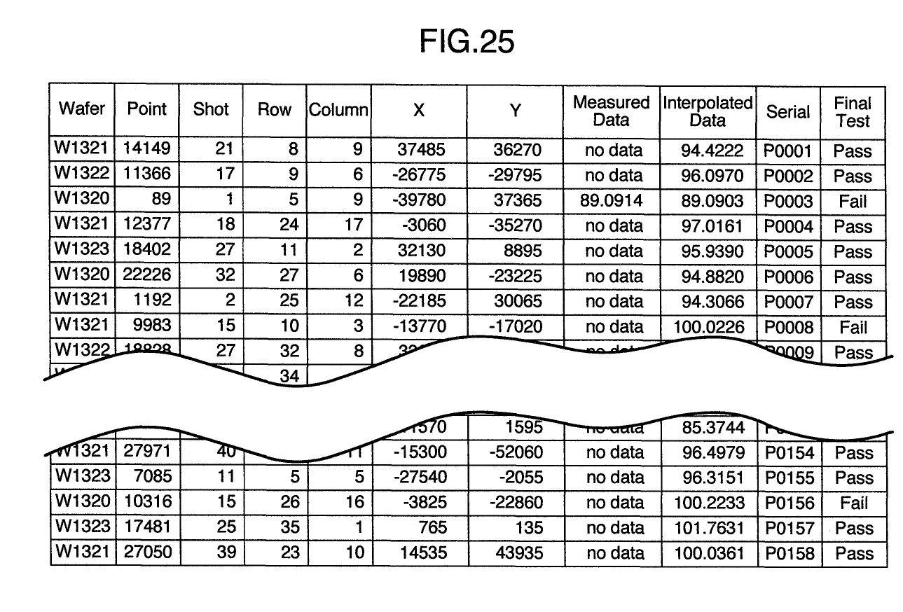

FIG. 25 shows a table that connects measured data, obtained by applying the measuring coordinate calculation program and the measuring program to the measurement of how well the wafers have been fabricated, or finished level of wafers, to the result of final tests on the magnetic heads in magnetic recording devices as final products. More specifically, the first column represents serial numbers of wafers. Second to seventh column represent serial numbers (Point) of magnetic heads in each wafer, exposure shots (Shot), coordinate of the ordinate in the exposure shot (Row), coordinate of the abscissa in the exposure shot (Column), X-coordinate on the abscissa 263 and Y-coordinate on the ordinate 264. Eighth column indicates actually measured dimension data; and ninth column represents dimension data approximated by the curved surface approximation, namely approximated values. 10th and 11th column indicate serial numbers of magnetic recording devices and the results of final tests of the magnetic recording devices. What this data shows is that the actually measured dimension data are few because they are sampled and measured in the surface of the wafer, and thus cannot be connected to magnetic heads and magnetic recording devices. On the other hand, the dimension data approximated by the curved surface approximation can be connected with a string to all the magnetic recording devices. By checking these data with the method described in JP-A-2007-264914 and the statistical hypothesis testing to see whether the products have passed or failed, it is possible to determine if the dimension of the device when formed on the wafer is the cause of the product failure.

### Embodiment 6

In embodiment 1, a method has been explained which approximates a curved surface with a B-spline based on the S selected coordinates and calculates measuring coordinates where approximation errors are minimal. In embodiment 2, a method has been described which uses measuring coordinates obtained by combining (S-T) randomly selected measuring coordinates and T measuring coordinates located along the outer circumference of the wafer. In embodiment 6, a method that realizes the merits of both of embodiment 1 and embodiment 2 will be explained.

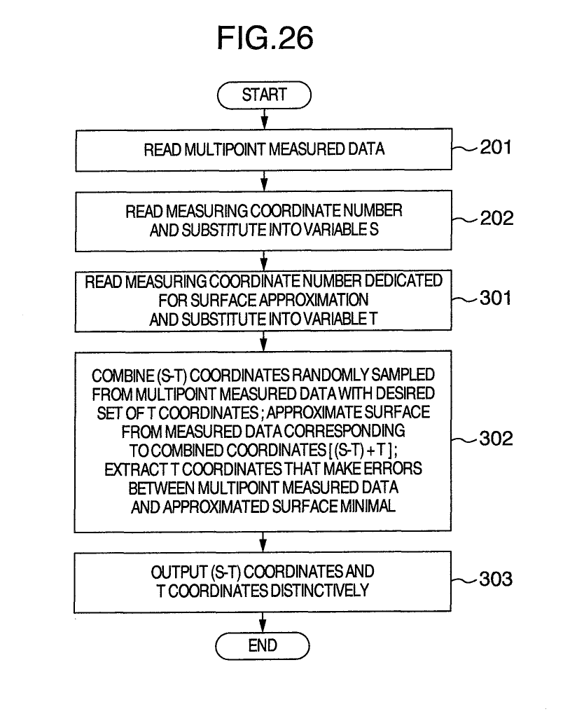

FIG. 26 shows an example flow chart of the measuring coordinate calculation program 1161. Step 201, as in FIG. 2, reads in dimension data that have been experimentally measured beforehand at many positions on the entire surface of a wafer, i.e., multipoint measured data. Next, step 202 reads the number of measuring coordinates at which measurements are planned to be made by the measuring apparatus of this invention and substitutes it into the variable S. Next, step 301 reads the number of measuring coordinates dedicated for curved surface approximation and substitutes it into the variable T. Then, step 302 randomly samples (S-T) coordinates from the multipoint measured data read in by step 201, approximates a curved surface from {(S-T)+T} coordinates, or S coordinates, and measured data corresponding to these coordinates and extracts T coordinates where errors between the multipoint measured data and the approximated curved surface are minimal. More specifically, the extraction of T coordinates is done by an optimization method that combines any of the hill climbing algorithm, multi-start algorithm, simulated annealing algorithm and hereditary algorithm. Next, step 303 writes the (S-T) coordinates and the T coordinates, both extracted by step 302, distinctively.

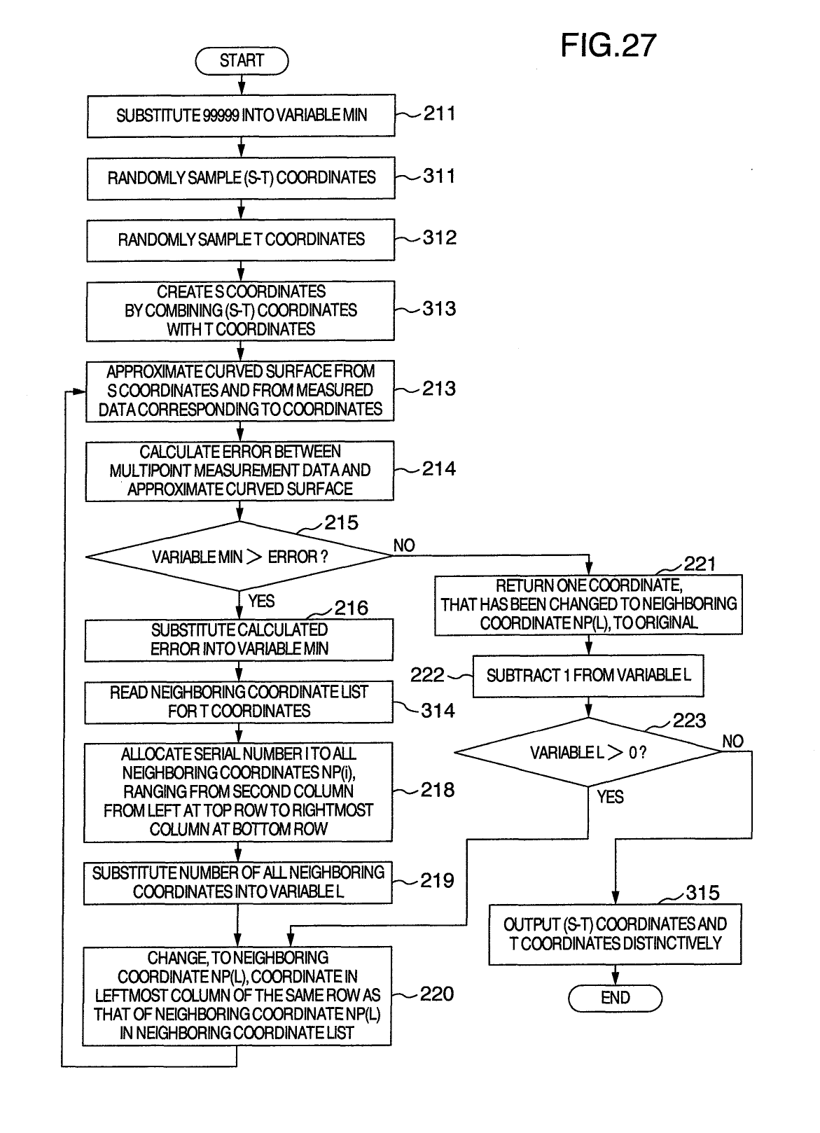

FIG. 27 is an example flow chart showing the processing of the step 302 in greater detail that uses the hill climbing algorithm, the most common local search algorithm. Step 211 substitutes an extremely large value into the variable MIN. While 99999 is shown in the figure, any value may be used as long as it is a large number. Next, step 311 randomly samples (S-T) coordinates from the multipoint measured data read in by step 201. Next, step 312 randomly samples T coordinates from the multipoint measured data, excluding the (S-T) coordinates. Then, step 313 combines the (S-T) coordinates and the T coordinates to create S coordinates. Next, step 213 approximates a curved surface by using the newly created S coordinates and the dimension data corresponding to these coordinates. Although the inventors of this invention use a B-spline surface for the approximation, the approximation method is not limited to the B-spline surface. Other methods include one that approximates various free curved surfaces and is used in 3-dimensional CAD and for restoration of 3-dimensional images, and an application of polynomials to curved surfaces. Next, step 214 calculates errors between the multipoint measured data and the approximated curved surface. The errors can be calculated using equation 1.

Next, step 215 compares the error with the variable MIN. If the variable MIN is greater than the error, the processing proceeds to step 216. If not, it moves to step 221. Step 216 substitutes the error into the variable MIN. Next, step 314 reads a list of coordinates neighboring the T coordinates. Next, step 218 allocates serial numbers i to all the neighboring coordinates NP(i) in the neighboring coordinate list read in, ranging from the second column from the left in the top row to the rightmost column in the bottom row. Next, step 219 substitutes the number of all neighboring coordinates into the variable L. Next, step 220 changes the coordinate at the leftmost column in the same row as that of the neighboring coordinate NP(L) in the neighboring coordinate list to the neighboring coordinate NP(L), before returning to step 213.

If, on the other hand, the processing moves from step 215 to step 221, it returns the one coordinate at the leftmost column, which has been changed to the neighboring coordinate NP(L) by step 220, to its original coordinate. Next, step 222 subtracts 1 from the variable L. Next, if step 223 finds that the variable L is greater than 0, the processing moves to step 220. If the variable is equal to or less than 0, the processing moves to step 315. Step 315 outputs the (S-T) coordinates and the T coordinates distinctively.

As in the case of embodiment 2 shown in FIG. 20, embodiment 6 approximates a curved surface by using the S coordinates, created by combining the (S-T) coordinates and the T coordinates, and the measured data for the S coordinates. For the management of averages and dispersions, it is advised that the randomly sampled (S-T) pieces of measured data that maintain randomness be used. Although embodiment 6 has shown an example in which the variable T is input beforehand, the measuring coordinate calculation program 1161 may allow various values to be entered into the variable T so that a balance between the variable S and the variable T can be changed desirably by entering the variable S. While it is a fact that, the greater the variable T, the higher the precision with which the characteristics can be checked over the entire surface of the wafer, the number of (S-T) coordinates used for the management of averages and dispersions decreases. On the other hand, as the variable T becomes small, it is difficult to check the characteristics over the entire surface of the wafer. But the small variable T improves the reliability of averages and dispersions. The balance between them may be determined according to the circumstance to which this invention is applied.

It should be further understood by those skilled in the art that although the foregoing description has been made on embodiments of the invention, the invention is not limited thereto and various changes and modifications may be made without departing from the spirit of the invention and the scope of the appended claims.

1. A measuring apparatus which approximates with a curved surface a distribution of characteristics of devices formed on a substrate by using values actually measured at a limited number of points and outputs characteristic values of all devices or a specified device, the measuring apparatus comprising:
a means to (1) read multipoint measured data measured on substrates that are same kind of a substrate to be evaluated and a number of points used for measurement, and (2) search for local solutions, in which errors between the curved surface approximation and the multipoint measured data are minimal, to extract a set of the point number of measuring coordinates, the curved surface approximation using measured data at any of sets of the point number of measuring coordinates, the sets being sampled from the coordinates of the multipoint measured data;
a measuring means to measure device characteristics at the extracted measuring coordinates on the surface of the substrate to be evaluated;
a curved surface approximation means to approximate a curved surface from the extracted measuring coordinates and the device characteristics measured at these coordinates; and
an output means to output the approximated device characteristics from the result of the curved surface approximation of the device characteristics on the substrate to be evaluated.

2. A measuring apparatus which approximates with a curved surface a distribution of characteristics of devices formed on a substrate by using values actually measured at a limited number of points and outputs characteristic values of all devices or a specified device, the measuring apparatus comprising:
a measuring coordinate calculation means to read a number of points S used for measurement and a number of points T to be arranged along an outer circumference of the substrate, the number of points T being included in the number of points S, and calculate measuring coordinates by combining (S-T) randomly chosen measuring coordinates, arranged in the surface of the substrate to be evaluated, with T measuring coordinates set along the outer circumference of the substrate;
a measuring means to measure device characteristics at the calculated measuring coordinates in the surface of the substrate to be evaluated;
a curved surface approximation means to approximate a curved surface from the calculated measuring coordinates and the device characteristics measured at these coordinates; and
an output means to output the approximated device characteristics from the result of the curved surface approximation of the device characteristics on the substrate to be evaluated.

3. A measuring apparatus according to claim 1, wherein dimensions of patterns formed are measured as the device characteristics.

4. A measuring apparatus according to claim 1, wherein the processing of approximating, with a curved surface, device characteristic values at the number of points on the substrate used for measurement is performed by using a B-spline surface.

5. A method of setting measuring coordinates at which characteristics of devices formed on a substrate are to be measured, the measuring coordinate setting method comprising the steps of:
inputting multipoint measured data measured on substrates that are same kind of a substrate to be evaluated and a number of points used for measurement; and
searching for local solutions, in which errors between the curved surface approximation and the multipoint measured data are minimal, to calculate a set of the point number of measuring coordinates, the curved surface approximation using measured data at any of sets of the point number of measuring coordinates, the sets being sampled from the coordinates of the multipoint measured data.

6. A measuring coordinate setting method according to claim 5, wherein the step of searching for local solutions, in which errors between the curved surface approximation and the multipoint measured data are minimal, to calculate a set of the point number of measuring coordinates, the curved surface approximation using measured data at any of sets of the point number of measuring coordinates, involves:
taking the point number of measuring coordinates, randomly sampled from the coordinates of the multipoint measured data, as initial measuring coordinates;
defining measuring coordinates on devices at 8-neighbor positions with respect to each of the initial measuring coordinates as neighboring coordinates;
if when the individual measuring coordinates are replaced with the neighboring coordinates successively, there is an improvement that errors between the curved surface approximation, based on measured data at the point number of measuring coordinates, and the multipoint measured data are smaller than before the replacement of coordinates, finalizing the process of replacing the measuring coordinates with the neighboring coordinates;
repeating the process of replacing all the initial measuring coordinates with all neighboring coordinates to evaluate the errors; and
determining the finalized measuring coordinates.

7. A method of setting measuring coordinates at which characteristics of devices formed on a substrate are to be measured, the measuring coordinate setting method comprising the steps of:
inputting multipoint measured data measured on substrates that are same kind of a substrate to be evaluated and a number of points used for measurement; and
selecting the point number of data from the multipoint measured data and, in a statistical hypothesis testing using the selected data and the multipoint measured data as input, calculating and outputting measuring coordinates at which a significance probability becomes maximum.

8. A method of calculating a number of measuring coordinates at which characteristics of devices formed on a substrate are to be measured, the measuring coordinate number calculation method comprising the steps of:
inputting multipoint measured data;
setting a plurality of numbers of points for measurement;
selecting the point number of data from the multipoint measured data, approximating a curved surface using the selected data, and calculating measuring coordinates at which errors between approximated data and the multipoint measured data are minimal; and
evaluating the errors for the point number.

9. A measuring apparatus which approximates with a curved surface a distribution of characteristics of devices formed on a substrate by using values actually measured at a limited number of points and outputs characteristic values of all devices or a specified device, the measuring apparatus comprising:
a means to (1) read multipoint measured data measured on substrates that are same kind of a substrate to be evaluated and a number of points S and a number of points T used for measurement, and (2) search for local solutions, in which errors between the curved surface approximation and the multipoint measured data are minimal, to extract a set of (S-T) measuring coordinates and a set of T measuring coordinates, the curved surface approximation using measured data at S measuring coordinates, the S measuring coordinates being created by combining any of sets of the T measuring coordinates and the randomly chosen (S-T) measuring coordinates, the sets of the T measuring coordinates being sampled from the coordinates of the multipoint measured data;
a measuring means to measure device characteristics at the extracted measuring coordinates in the surface of the substrate to be evaluated;
a curved surface approximation means to approximate a curved surface from the extracted measuring coordinates and the device characteristics measured at these coordinates; and
an output means to output the approximated device characteristics from the result of the curved surface approximation of the device characteristics on the substrate to be evaluated.

10. A method of setting measuring coordinates at which characteristics of devices formed on a substrate are to be measured, the measuring coordinate setting method comprising the steps of:
inputting multipoint measured data measured on substrates that are same kind of a substrate to be evaluated and a number of points S and a number of points T used for measurement; and
searching for local solutions, in which errors between the curved surface approximation and the multipoint measured data are minimal, to calculate a set of (S-T) measuring coordinates and a set of T measuring coordinates, the curved surface approximation using measured data at S measuring coordinates, the S measuring coordinates being created by combining any of sets of the T measuring coordinates and the randomly chosen (S-T) measuring coordinates, the sets of the T measuring coordinates being sampled from the coordinates of the multipoint measured data;
